(19) United States
(12) Patent Application Publication
(10) Pub. No.: US 2014/0055731 A1
(43) Pub. Date: Feb. 27, 2014

(54) INTEGRATED FORCE LOCALIZER AND DIGITIZER AND/OR LCD DRIVE FOR CHOLESTERIC LIQUID CRYSTAL DISPLAY

(71) Applicant: Bernard Kirk Rihn, Snohomish, WA (US)

(72) Inventor: Bernard Kirk Rihn, Snohomish, WA (US)

(73) Assignee: Microsoft Corporation, Redmond, WA (US)

(21) Appl. No.: 13/592,586

(22) Filed: Aug. 23, 2012

(51) Int. Cl. G02F 1/1335; G02F 1/1333

(52) U.S. Cl. 349/115; 445/25

(57) ABSTRACT

A cholesteric liquid crystal display and a method of making are provided. The cholesteric liquid crystal display may include a first layer of insulating material forming a force backplate and having a conductive trace laminated thereto. Components may be soldered to and electrically connected to the conductive trace. A second layer of insulating material may be laminated over the first layer, the soldered components, and the conductive trace to form a thin smooth layer. A pressure-sensitive cholesteric liquid crystal display layer may be laminated to a surface of the thin smooth layer. The force backplate is substantially thick such that when pressure is applied to a surface of the pressure-sensitive cholesteric liquid crystal display layer with an implement dragged across a surface thereof, a reflective state of liquid crystal is changed and a line representative of a thickness of the implement is displayed.

### BACKGROUND

When cholesteric liquid crystal is combined with a polymer solution, in very specific ratios, and is placed between two sheets of polyethylene terephthalate (PET) a surface is created having a reflectivity modulated by pressure. When enough localized pressure is applied, an energy state of the liquid crystal is raised to a level such that a state of the liquid crystal changes and becomes reflective. For the abovementioned state change to occur in a localized manner, the PET sheets have a stiff smooth backing plate. Otherwise, pressure provided to the PET sheets spreads as a lower PET sheet deforms, thereby causing a stroke of a writing implement to appear much broader than it actually is.

Products currently being sold include an acrylonitrile butadiene styrene (ABS) backplate behind a bottom PET sheet and adhere a polyimide digitizer sheet beneath the backplate resulting in a stackup that is thick, unnecessarily complicated and expensive.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In an embodiment consistent with the subject matter of this disclosure, a cholesteric liquid crystal display and digitizer assembly, which is thinner than a conventional cholesteric liquid crystal display and digitizer assembly, is provided. The liquid crystal display may include a conductive material laminated to a first insulating layer and forming a conductive trace. The first insulating layer may include FR-4 glass epoxy, ABS, or other insulating material. The conductive material may include, but not be limited to, copper. Components may be soldered to portions of the conductive trace to form a digitizer printed circuit board integrated with the first insulating layer, a liquid crystal display drive printed circuit board integrated with the first insulating layer, or both of the digitizer printed circuit board and the liquid crystal display drive printed circuit board integrated with the first insulating layer. A second insulating layer may be laminated over a surface of the soldered components, the conductive trace and the first insulating layer to form the second insulating layer with a smooth surface. A pressure-sensitive cholesteric liquid crystal display layer may be laminated onto the smooth surface of the second insulating layer. The first insulating layer forms a force backplate and is substantially thick, such that an application of pressure, with an implement, to an area of a surface of the pressure-sensitive cholesteric liquid crystal display layer and dragging of the implement across the surface changes a state of liquid crystal of the cholesteric pressure-sensitive liquid crystal display layer to a reflective state, thereby causing a line to appear across the surface of the pressure-sensitive cholesteric liquid crystal display layer. A thickness of the line is a representative of a size of a portion of the implement that comes into pressured contact with the pressure-sensitive cholesteric liquid crystal display layer.

In a second embodiment consistent with the subject matter of this disclosure, a method for making a cholesteric liquid crystal display is provided. A conductive material may be laminated to a first insulating layer. The conductive material may include, but not be limited to, copper. The first insulating layer may include, but not be limited to, FR-4 glass epoxy or ABS. The conductive material may be etched to form a conductive trace on the first insulating layer. Components may be soldered to portions of the conductive trace to form at least one of a digitizer printed circuit board or a liquid crystal display drive printed circuit board integrated with the first insulating layer. A second insulating layer may be laminated over the soldered components, the conductive trace and the first insulating layer to form a smooth surface of the second insulating layer. A pressure sensitive cholesteric liquid crystal display layer may be laminated over the smooth surface of the second insulating layer. The first insulating layer has a thickness, such that when pressure is applied with an implement to a surface of the pressure-sensitive cholesteric liquid crystal display layer and the implement is dragged across the surface, a state of liquid crystal of the pressure-sensitive cholesteric liquid crystal display layer changes to a reflective state, thereby causing a line to appear across the surface of the pressure-sensitive cholesteric liquid crystal display layer. The line has a thickness representative of a size of a portion of the implement that has come into pressured contact with the pressure-sensitive cholesteric liquid crystal display layer.

### DRAWINGS

In order to describe the manner in which the above-recited and other advantages and features can be obtained, a more particular description is described below and will be rendered by reference to specific embodiments thereof which are illustrated in the appended drawings. Understand that these drawings depict only typical embodiments and are not therefore to be considered to be limiting of its scope. Implementations will be described and explained with additional specificity and detail through the use of the accompanying drawings.

FIG. 1 is a block diagram illustrating an exemplary cholesteric liquid crystal display device consistent with the subject matter of this disclosure.

FIG. 2 illustrates a portion of a conventional cholesteric liquid crystal display.

FIG. 3 shows a portion of an exemplary cholesteric liquid crystal display in an embodiment consistent with the subject matter of this disclosure.

FIG. 4 is a flowchart illustrating an exemplary process for making a cholesteric liquid crystal display consistent with the subject matter of this disclosure.

FIG. 5 illustrates a conductive material laminated to an insulating layer during an exemplary method for making a cholesteric liquid crystal display consistent with the subject matter of this disclosure.

FIG. 6 shows a conductive trace, etched from conductive material, laminated to a surface of an insulating layer during a method of making a cholesteric liquid crystal display consistent with the subject matter of this disclosure.

FIG. 7 is illustrative of an exemplary pressure-sensitive liquid crystal display layer, which may be used in various implementations consistent with the subject matter of this disclosure.

### DETAILED DESCRIPTION

### Overview

Embodiments consistent with the subject matter of this disclosure provide a force localizer backplate for a cholesteric liquid crystal display (LCD) integrated with either a digitizer, an LCD drive, or both the digitizer and the LCD drive. In some embodiments, the digitizer may be made from FR-4, which is a grade designation assigned to glass-reinforced epoxy laminate sheets, tubes, rods and printed circuit boards (PCBs). FR-4 is a composite material composed of woven fiberglass cloth with a flame resistant epoxy resin binder. FR-4 is commonly used as an electrical insulator having considerable mechanical strength.

Various embodiments consistent with the subject matter of this disclosure may integrate a force backplate, an electromagnetic digitizer, and/or control and display drive electronics into a single part. The digitizer may be fabricated via a conventional printed circuit board fabrication process. A number of layers of different types of insulating material, including, but not limited to, FR-4 may be laminated together to form a stiff force backplate, which may be integrated with the digitizer or the control and display drive electronics, or both the digitizer and the control and display drive electronics.

In some embodiments, the layers of different types of insulating material may include different types of FR-4 resulting in a cheaper and thinner integrated force backplate as compared with a non-integrated force backplate, digitizer, and control and display drive electronics fabricated via a relatively expensive polyimide process.

### Exemplary Display Device

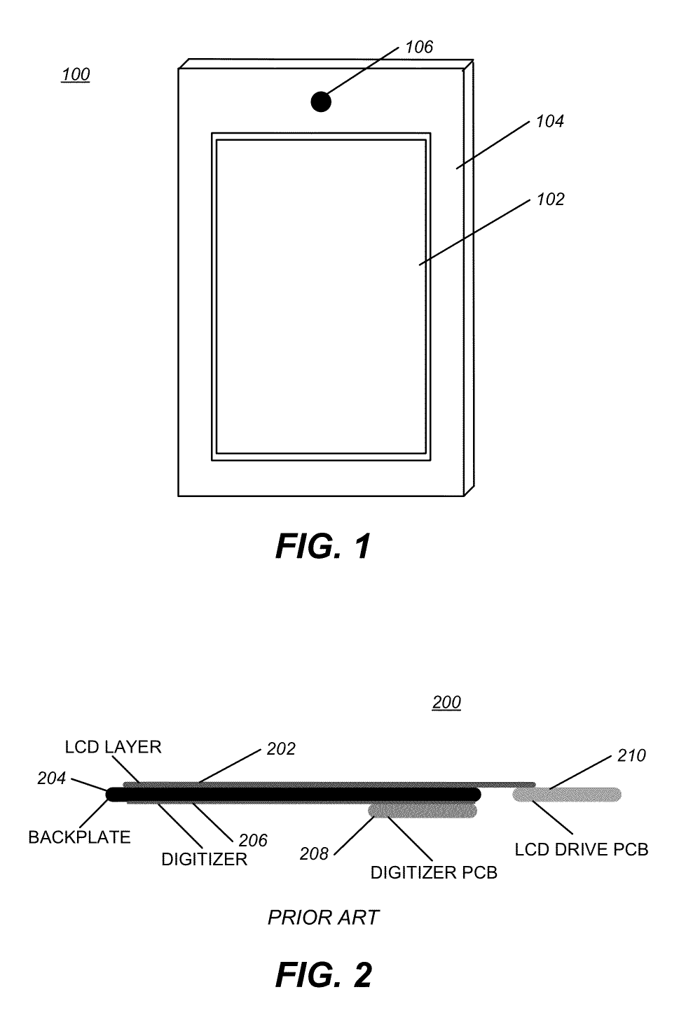

FIG. 1 illustrates an exemplary cholesteric liquid crystal display (LCD) device 100, in which embodiments consistent with the subject matter of this disclosure may be implemented. Display device 100 may be an LCD writing tablet, a tablet computing device, or another type of LCD writing device. Display device 100 may include a cholesteric LCD display area 102, on which a user may write with a writing implement and on which lines may be displayed as a result of writing with the writing implement. The writing implement may be a stylus, a user's finger, or other implement that can be used to apply pressure to and be dragged across cholesteric LCD display area 102.

Cholesteric LCD display area 102 may be mounted in a frame 104 having an open area through which cholesteric LCD display area 102 can be observed. Cholesteric liquid crystal display (LCD) area 102 may be electrically switched between one of two stable states; a reflective state or a transmissive state. In some embodiments, a button 106 may be placed on a portion of frame 104, such that when button 106 is activated or pressed, cholesteric LCD display area 102 is electronically switched to the transmissive state, thereby erasing lines drawn on cholesteric LCD display area 102.

In FIG. 1, button 106 is placed at a top portion of frame 104 facing a user. In other embodiments, button 106 may be placed at a different portion of frame 104. In some embodiments, button 106 may not be a button at all, but instead, may include a sensor that senses application of at least a predetermined amount of pressure before activating and causing cholesteric LCD display area 102 to be erased. Other types of buttons, or sensors may be used in other embodiments for a user to indicate a desire to erase cholesteric LCD display area 102.

Further, FIG. 1 shows frame 104 having a rectangular shape. In other embodiments, frame 104 may have a different shape, including, but not limited to, a circular shape, an oval shape, a polygonal shape, or another shape.

### Cholesteric Liquid Crystal Display

FIG. 2 illustrates a portion of a conventional cholesteric LCD 200. Cholesteric LCD 200 may include an LCD layer 202, a force backplate 204, a polyimide digitizer sheet 206, a digitizer printed circuit board (PCB) 208, and an LCD drive PCB 210.

LCD layer 202 may include reflective bistable polymer-dispersed cholesteric liquid crystal laminated between two conductive polymer coated polyethylene terephthalate (PET) substrates. At least a portion of LCD layer 202 is adhered to a stiff, smooth force backplate 204 made of injection molded acrylonitrile butadiene styrene (ABS). Polyimide digitizer sheet 206 is adhered to an underside of force backplate 204. Digitizer PCB 208 is adhered to polyimide digitizer sheet 206. At least a portion of LCD drive PCB 210 may be adhered to LCD layer 202.

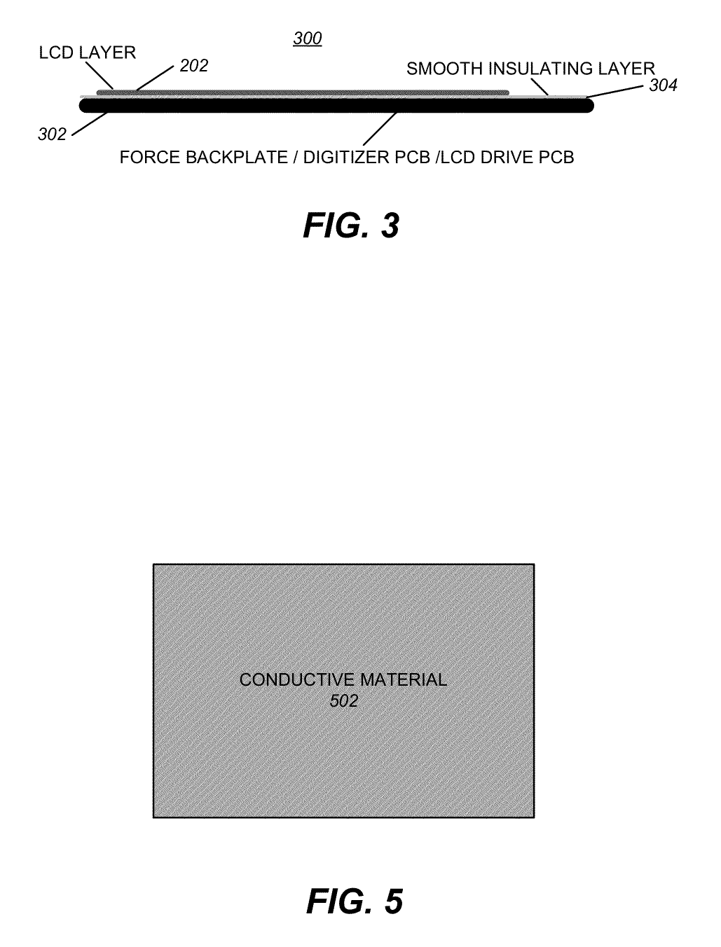

FIG. 3 illustrates a portion of a cholesteric LCD 300 consistent with the subject matter of this disclosure. Cholesteric LCD 300 may include a force backplate 302 integrated with a digitizer PCB and/or an LCD drive PCB. In some embodiments, drive components for cholesteric LCD 300 and sense components for a digitizer may be integrated onto a same sheet of FR-4, thereby eliminating an extra drive electronics PCB. Further, force backplate 302 may act as an inner support structure. As a result, an outer cosmetic structure may be thinner than that of a conventional cholesteric LCD.

In some embodiments, force backplate 302 may be made of FR-4 instead of more expensive ABS. A relatively thin layer of ultra-smooth FR-4 304 may be laminated on a top surface of force backplate 302 integrated with the digitizer PCB and/or the LCD drive PCB. Integrated circuits for driving cholesteric LCD display 300, driving to or sensing from a digitizer and communicating with a host, may reside on a same PCB resulting in a thinner, cheaper cholesteric LCD in comparison with a conventional cholesteric LCD.

### Method of Making

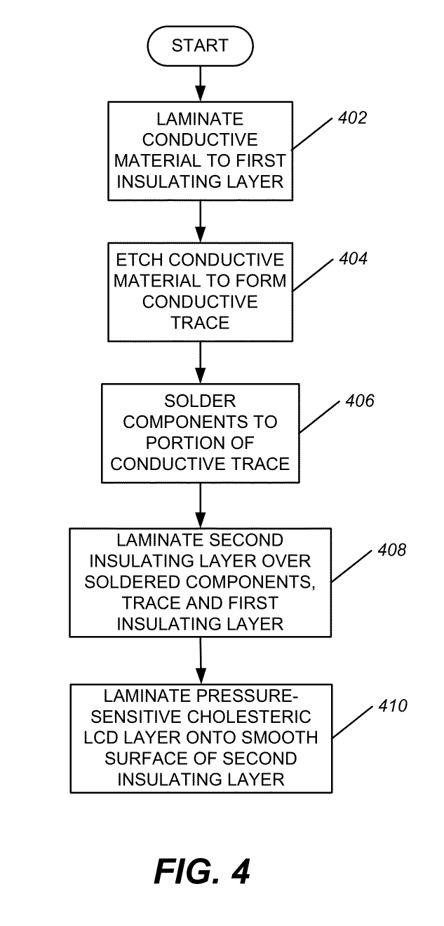

FIG. 4 is a flowchart illustrating a process for making a cholesteric LCD consistent with the subject matter of this disclosure. The method may begin with laminating a conductive material to a first insulating layer (act 402). The first insulating layer may be a force backplate made from an insulating material, which may include, but not be limited to, FR-4. The conductive material may include, but not be limited to, copper. FIG. 5 shows the conductive material 502 laminated onto the force backplate (not shown).

Next, the conductive material laminated to the force backplate may be etched to form a conductive trace (act 404). The conductive material may be etched using any conventional etching process. Next, various components may be soldered to portions of the conductive trace on the force backplate (act 406) and may form electrical connections between the components and the conductive trace. This may be followed by laminating an ultra-smooth second insulating layer over the soldered components, the conductive trace, and the first insulating layer. In some embodiments, the second insulating layer may be made of FR-4 (act 408). A pressure-sensitive cholesteric LCD layer may then be laminated onto the ultra-smooth second insulating layer.

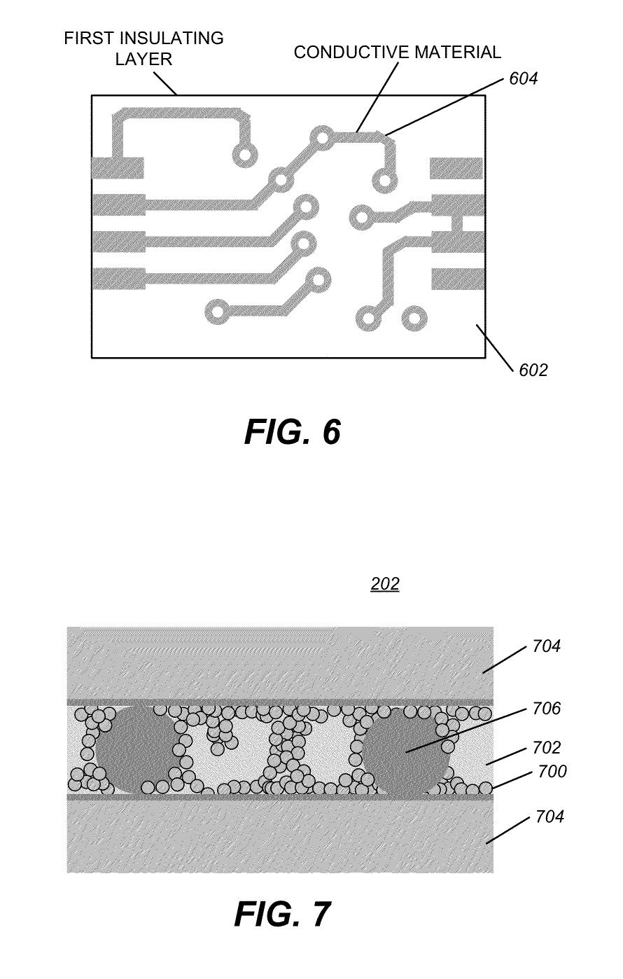

FIG. 6 shows an exemplary first insulating layer 602 having etched conductive material 604 laminated thereto. The first insulating layer may include, but not be limited to, FR-4 and the conductive material may include, but not be limited to, copper in some embodiments.

FIG. 7 illustrates a cross-section of exemplary LCD layer 202 used in various embodiments. LCD layer 202 may include liquid crystal 702, having polymer 700 dispersed therein, laminated between two conductive polymer (PEDOT) coated PET substrates 704. Spacers 706 may be provided at periodic intervals between the two PET substrates 704. Polymer 700 may form pillars that support PET substrates 704 and limit a flow of liquid crystal 702 when pressure is applied during writing.

### CONCLUSION

Embodiments consistent with the subject matter of this disclosure are related to a cholesteric liquid crystal display, which is thinner than conventional cholesteric liquid displays. In some embodiments, insulating layers of the cholesteric liquid crystal display may include FR-4 glass epoxy, which is less expensive than ABS used in conventional cholesteric liquid crystal displays.

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims. Further, in other embodiments, an order of acts performed may vary. For example, in other embodiments, an order of the acts included in the flowchart of FIG. 4 may vary from the order shown in FIG. 4.

Accordingly, the appended claims and their legal equivalents define embodiments, rather than any specific examples given.

We claim as our invention:

1. A method of making a cholesteric liquid crystal display, the method comprising:
laminating a conductive material to a first insulating layer;
etching the conductive material laminated to the first insulating layer to form a conductive trace on the first insulating layer;
soldering components to portions of the conductive trace on the first insulating layer to form at least one of a digitizer printed circuit board integrated with the first insulating layer or a liquid crystal display drive printed circuit board integrated with the first insulating layer;
laminating a second insulating layer over the soldered components, the conductive trace and the first insulating layer to form the second insulating layer with a smooth surface; and
laminating a pressure-sensitive cholesteric liquid crystal display layer onto the smooth surface of the second insulating layer, wherein
the first insulating layer is substantially thick so that an application of pressure to an area of the pressure-sensitive cholesteric liquid crystal display layer with an implement and dragging of the implement across a surface of the pressure-sensitive cholesteric liquid crystal display layer changes a state of liquid crystal to a reflective state, thereby causing a line to appear across the surface of the pressure-sensitive cholesteric liquid crystal display layer, a thickness of the line being representative of a size of a portion of the implement that comes into pressured contact with the pressure-sensitive cholesteric liquid crystal display layer.

2. The method of claim 1, wherein the soldering components to portions of the conductive trace on the first insulating layer forms the digitizer printed circuit board integrated with the first insulating layer.

3. The method of claim 1, wherein the soldering components to portions of the conductive trace on the first insulating layer forms the liquid crystal display drive printed circuit board integrated with the first insulating layer.

4. The method of claim 1, wherein the conductive material includes copper.

5. The method of claim 1, wherein the first insulating layer comprises acrylonitrile butadiene styrene.

6. The method of claim 1, wherein the first insulating layer and the second insulating layer comprise FR-4 glass epoxy.

7. The method of claim 1, wherein the pressure-sensitive cholesteric liquid crystal display layer comprises:
a reflective bistable polymer-dispersed cholesteric liquid crystal laminated between two conductive polymer coated polyethylene-terephthalate substrates.

8. A cholesteric liquid crystal display comprising:
a force backplate comprising a layer of insulating material and having a conductive trace laminated thereto;
a plurality of components soldered to the conductive trace and forming electrical connections between each of the plurality of components and the conductive trace, the plurality of components and the conductive trace having a second layer of the insulating material laminated thereon and forming a smooth layer, the smooth layer being thinner than the force backplate; and
a pressure-sensitive cholesteric liquid crystal display layer laminated to a surface of the smooth layer of the insulating material, wherein:
the force backplate has a thickness such that an application of pressure to an area of the pressure-sensitive cholesteric liquid crystal display layer with an implement dragged across a surface of the pressure-sensitive cholesteric liquid crystal display causes a change of a state of liquid crystal to a reflective state, thereby causing a line to be displayed, the thickness of the line being representative of a size of a portion of the implement that comes into pressured contact with the pressure-sensitive cholesteric liquid crystal display layer, and the plurality of components soldered to the conductive trace and forming the electrical connections between each of the plurality of components and the conductive trace form at least one of a digitizer printed circuit board or a liquid crystal display drive printed circuit board integrated with the force backplate.

9. The cholesteric liquid crystal display of claim 8, wherein the plurality of components soldered to the conductive trace and forming the electrical connections between each of the plurality of components and the conductive trace form the digitizer printed circuit board integrated with the force backplate.

10. The cholesteric liquid crystal display of claim 8, wherein the plurality of components soldered to the conductive trace and forming the electrical connections between each of the plurality of components and the conductive trace form the liquid crystal display drive printed circuit board integrated with the force backplate.

11. The cholesteric liquid crystal display of claim 8, wherein the insulating material comprises FR-4 glass epoxy.

12. The cholesteric liquid crystal display of claim 8, wherein the insulating material comprises acrylonitrile butadiene styrene.

13. The cholesteric liquid crystal display of claim 8, wherein the conductive trace comprises copper.

14. The cholesteric liquid crystal display of claim 8, wherein the cholesteric liquid crystal display layer comprises:
a reflective bistable polymer-dispersed cholesteric liquid crystal laminated between two conductive polymer coated polyethylene-terephthalate substrates.

15. A cholesteric liquid crystal display comprising:
a first layer of insulating material forming a force backplate and having a conductive trace laminated thereto;
a plurality of components soldered to the conductive trace and forming electrical connections between each of the plurality of components and the conductive trace, the plurality of components and the conductive trace having a second layer of the insulating material laminated thereon and forming a smooth layer, the smooth layer being thinner than the first layer of the insulating material; and
a pressure-sensitive cholesteric liquid crystal display layer laminated to a surface of the smooth layer of the insulating material, wherein:
the force backplate has a thickness such that an application of pressure to an area of the pressure-sensitive cholesteric liquid crystal display layer with an implement dragged across a surface of the pressure-sensitive cholesteric liquid crystal display causes a change of state of liquid crystal to a reflective state, thereby causing a line to be displayed, the thickness of the line being representative of a size of a portion of the implement that comes into pressured contact with the pressure-sensitive cholesteric liquid crystal display layer, and
the plurality of components soldered to the conductive trace and forming the electrical connections between each of the plurality of components and the conductive trace form a digitizer printed circuit board and a liquid crystal display drive printed circuit board integrated with the force backplate.

16. The cholesteric liquid crystal display of claim 15, wherein the conductive trace includes copper.

17. The cholesteric liquid crystal display of claim 15, wherein the insulating material comprises acrylonitrile butadiene styrene.

18. The cholesteric liquid crystal display of claim 15, wherein the insulating material comprises FR-4 glass epoxy.

19. The cholesteric liquid crystal display of claim 15, wherein the cholesteric liquid crystal display layer comprises:
a reflective bistable polymer-dispersed cholesteric liquid crystal laminated between two conductive polymer coated polyethylene-terephthalate substrates.

20. The cholesteric liquid crystal display of claim 19, wherein the two conductive polymer coated polyethylene-terephthalate substrates are coated with a PEDOT-based conductive polymer.
